(19) United States
(12) Patent Application Publication
(10) Pub. No.: US 2003/0065856 A1
(43) Pub. Date: Apr. 3, 2003

(54) Network adapter with multiple event queues

(75) Inventors: Michael Kagan, Zichron (IL); Dafna Levenvirth, Jerusalem (IL); Elazar Raab, Haifa (IL); Margarita Schnitman, Netivot (IL); Diego Crupnicoff, Buenos Aires (AR); Benjamin Koren, Zichron Yaakov (IL); Gilad Shainer, Karkur (IL); Ariel Shachar, Haifa (IL)

Correspondence Address: OBLON, SPIVAK, MCCLELLAND, MAIER & NEUSTADT, P.C., 1940 DUKE STREET, ALEXANDRIA, VA, 22314, US

(73) Assignee: MELLANOX TECHNOLOGIES LTD., Yokneam (IL)

(21) Appl. No.: 10/120,418

(22) Filed: Apr. 12, 2002

Related U.S. Application Data
(60) Provisional application No. 60/326,964, filed on Oct. 3, 2001.

(51) Int. Cl. G06F 13/24

(52) U.S. Cl. 710/263

(57) ABSTRACT

A method for communication between a network interface adapter and a host processor coupled thereto includes writing information using the network interface adapter to a location in a memory accessible to the host processor. Responsive to having written the information, the network interface adapter places an event indication in an event queue accessible to the host processor. It then asserts an interrupt of the host processor that is associated with the event queue, so as to cause the host processor to read the event indication and, responsive thereto, to process the information written to the location.

### CROSS-REFERENCE TO RELATED APPLICATION

This application claims the benefit of U.S. Provisional Patent Application No. 60/326,964, filed Oct. 3, 2001, which is incorporated herein by reference.

### FIELD OF THE INVENTION

The present invention relates generally to computer network communications, and specifically to interrupt handling and event generation in interaction between a host processor and a network interface adapter.

### BACKGROUND OF THE INVENTION

To deliver data to a host central processing unit (CPU), high-speed network communication adapters typically use direct memory access (DMA) to write the data to the host system memory. When the adapter has finished writing, it asserts an interrupt on one of the interrupt lines of the host bus or on an appropriate pin of the CPU itself. The interrupt causes the CPU to call an interrupt handler routine. While the interrupt handler is running, other software processes are blocked, and all interrupts are disabled. For this reason, it is important to minimize time spent in this routine.

The interrupt handler identifies the cause of the interrupt and places a corresponding event in an appropriate event queue. The event is subsequently scheduled by the operating system to be processed while running in “normal” (interrupt enabled) mode. A scheduler schedules the events for execution by applicable event handlers. The interrupt handler, scheduler and event handlers are typically provided as part of the host operating system (OS). The event handler determines the host application that is meant to receive the data that has been written to the memory, and informs the application that the data are ready to be read.

Once the adapter has asserted an interrupt, the interrupt is disabled, typically at least until the interrupt handler has determined the cause of the interrupt and placed the corresponding event in the appropriate queue. Only then can interrupts be re-enabled, so that other interrupts can be accepted. Disablement of the interrupt is necessary in order to prevent race conditions. When the CPU is busy, however, the disabled interrupt can cause a bottleneck in data processing and memory access by the network adapter. Furthermore, the event handling process itself, as described above, places an additional burden on CPU resources. It is generally desirable to reduce this processing burden, as well as to shorten the time between assertion of the interrupt by the network adapter and subsequent interrupt enablement by the CPU.

A further difficulty with interrupt handling arises in multi-CPU systems, in which different interrupts may be served by different CPUs. Typically, all interrupts in the system are initially routed to a single processor (i.e., the interrupt pin of one processor is asserted). This first processor decodes the interrupt cause and schedules execution of interrupt service either on the first processor itself or on other another processor, depending on interrupt and load balancing algorithms and policies. This approach results in asymmetric interrupt latency, since interrupts that are served by the first CPU are faster than others.

Packet network communication adapters are a central element in new high-speed, serial input/output (I/O) bus architectures that are gaining acceptance in the computer industry. In these systems, computing hosts and peripherals are linked together by a switching network, commonly referred to as a switching fabric, taking the place of parallel buses that are used in traditional systems. A number of architectures of this type have been proposed, culminating in the “InfiniBand™” (IB) architecture, which is described in detail in the InfiniBand Architecture Specification, Release 1.0 (October, 2000), which is incorporated herein by reference. This document is available from the InfiniBand Trade Association at www.infinibandta.org. The IB fabric is far faster than current commercially-available computer system buses. As a result, delays due to interrupt handling and event generation can cause significant performance bottlenecks in IB systems.

The host network adapter in IB systems is known as a host channel adapter (HCA). An application process on the host, referred to as a “consumer,” interacts with the HCA by manipulating transport service instances, known as “queue pairs” (QPs). When a consumer needs to open communications with some other entity via the IB fabric, it asks the HCA to provide the necessary transport resources by allocating a QP for its use. Each QP has two work queues: a send queue and a receive queue, and is configured with a context that includes information such as the destination address (referred to as the local identifier, or LID) for the QP, service type, and negotiated operating limits. Communication over the fabric takes place between a source QP and a destination QP, so that the QP serves as a sort of virtual communication port for the consumer.

To send and receive messages over the IB fabric, the consumer initiates a work request (WR) on a specific QP. Submission of the WR causes a work item, called a work queue element (WQE), to be placed in the appropriate queue of the specified QP for execution by the HCA. Executing the WQE causes the HCA to communicate with corresponding QPs of other channel adapter over the network by generating one or more outgoing packets and/or processing incoming packets.

When the HCA completes execution of a WQE, it places a completion queue element (CQE) on a completion queue, to be read by the consumer. The CQE contains or points to the information needed by the consumer to determine the WR that has been completed. To inform the consumer that it has added a new CQE to its completion queue, the HCA typically asserts an interrupt on the host CPU. The interrupt causes the host to generate and process an event, as described above, so that the consumer process receives the completion information written by the HCA.

Each consumer typically has its own set of send and receive queues, independent of work queues belonging to other consumers. Each consumer also creates one or more completion queues and associates each send and receive queue with a particular completion queue. It is not necessary that both the send and receive queue of a work queue pair use the same completion queue. On the other hand, a common completion queue may be shared by multiple QPs belonging to the same consumer. In any case, a busy HCA will typically generate many CQEs on a number of different completion queues. As a result, handling of the interrupts generated by the HCA and processing of the associated completion events can place a substantial burden on the host CPU. As described above, delays in interrupt handling can cause extended disablement of the interrupt, which can ultimately limit the speed at which the HCA transmits and receives packets.

### SUMMARY OF THE INVENTION

It is an object of some aspects of the present invention to provide methods that enhance the speed of interrupt processing by a host CPU, and to provide devices implementing such methods.

It is a further object of some aspects of the present invention to provide an improved network adapter device for coupling a host processor to a packet network, which implements improved methods for event reporting from the network adapter to the host processor.

It is yet a further object of some aspects of the present invention to provide more efficient methods for conveying completion information from a network adapter to a host processor, and particularly for reporting on completion of work requests involving sending and receiving data over a network.

In preferred embodiments of the present invention, a network interface adapter is configured to write event indications directly to event queues of a host processor. After placing an event in its appropriate event queue, the adapter asserts one of the processor interrupts. Preferably, when multiple interrupts are available (as in a multi-processor system, for example), the interrupt is uniquely assigned to the particular event queue. The host processor can then read and process the event immediately, using the appropriate event handler, rather than waiting for the event to be generated, enqueued and scheduled for service by the host operating system, as in systems known in the art.

Thus, the network interface adapter enables the host processor to achieve enhanced efficiency in processing events and reduces the time during which interrupts must remain disabled while events are being serviced by the processor. Furthermore, in multi-processor systems, the network interface adapter can reduce or eliminate the need for central interrupt handling by one of the processors, by permitting the user to pre-assign different event types to different processors. This pre-distribution of interrupts reduces the average interrupt response time and can be used to balance the load of interrupt handling among the processors.

In some preferred embodiments of the present invention, the network interface adapter asserts the interrupts to notify the host processor that it has written information to the host system memory, to be read and processed by the host. Preferably, the information comprises completion information, which the network interface adapter has written to one of a plurality of completion queues that it maintains to inform host application processes of the completion of work requests that they have submitted. The completion queues are mapped to different host event queues, wherein typically a number of completion queues may share the same event queue. In response to assertion of the interrupt by the network interface adapter, the host event handler reads the event and informs the appropriate application process that there is new information in its completion queue waiting to be read. This mode of interaction is particularly useful for passing completion queue elements (CQEs) from a host channel adapter (HCA) in an InfiniBand switching fabric to a host processor, but it may also be applied, mutatis mutandis, to other types of packet communication networks and to other adapter/host interactions.

There is therefore provided, in accordance with a preferred embodiment of the present invention, a method for communication between a network interface adapter and a host processor coupled thereto, the method including:

writing information using the network interface adapter to a location in a memory accessible to the host processor;

responsive to having written the information, placing an event indication, using the network interface adapter, in an event queue accessible to the host processor;

asserting an interrupt of the host processor that is associated with the event queue, so as to cause the host processor to read the event indication and, responsive thereto, to process the information written to the location.

Preferably, writing the information includes writing completion information regarding a work request submitted by the host processor to the network interface adapter. Most preferably, writing the completion information includes writing a completion queue element (CQE) to a completion queue. Additionally or alternatively, writing the completion information includes informing the host processor that the network interface adapter has performed at least one of sending an outgoing data packet and receiving an incoming data packet over a packet network responsive to the work request.

Typically, the information written to the location in the memory belongs to a given information category, and placing the event indication includes placing the event indication in a particular event queue that corresponds to the given information category, among a plurality of such event queues accessible to the host processor. Preferably, the given information category is one of a multiplicity of categories of the information written using the network interface adapter, and each of the multiplicity of the categories is mapped to one of the plurality of the event queues, so that placing the event indication includes placing the event indication in the particular event queue to which the given information category is mapped.

Additionally or alternatively, the interrupt is one of a multiplicity of such interrupts provided by the host processor, and each of the plurality of the event queues is mapped to one of the multiplicity of the interrupts, so that asserting the interrupt includes asserting the interrupt to which the particular event queue is mapped. Preferably, asserting the interrupt includes mapping the particular event queue uniquely to a specific one of the interrupts, to which none of the other event queues are mapped, and asserting the specific one of the interrupts. Most preferably, asserting the specific one of the interrupts includes invoking an event handler of the host processor to process the event indication in response to the interrupt, substantially without invoking an interrupt handler of the host processor.

In a preferred embodiment, the method includes writing context information with respect to the event queue to the memory using the host processor, and placing the event indication in the event queue includes reading the context information using the network interface adapter, and writing the event indication responsive to the context information.

There is also provided, in accordance with a preferred embodiment of the present invention, a method for communication between a host channel adapter (HCA) and a host processor coupled thereto, the method including:

writing a completion queue element (CQE) using the HCA to a completion queue accessible to the host processor;

responsive to having written the CQE, placing an event indication, using the HCA, in an event queue accessible to the host processor;

asserting an interrupt of the host processor that is associated with the event queue, causing the host processor to read the event indication and, responsive thereto, to process the CQE.

Preferably, writing the CQE includes informing the host processor that the network interface adapter has executed a work queue element (WQE) responsive to a work request submitted by the host processor to the HCA. Most preferably, informing the host processor includes notifying an application process that submitted the work request that that the HCA has performed at least one of sending an outgoing data packet and receiving an incoming data packet over a switch fabric responsive to the work request. Additionally or alternatively, the WQE belongs to a work queue assigned to the host processor, the work queue having a context indicating the completion queue to which the work queue is mapped, among a plurality of such completion queues maintained by the HCA, and wherein informing the host processor includes writing the CQE to the completion queue that is indicated by the context of the work queue.

Preferably, writing the CQE includes writing the CQE to an assigned completion queue among a multiplicity of such completion queues maintained by the HCA, and placing the event indication includes writing the event indication to a specific event queue to which the assigned completion queue is mapped, among a plurality of such event queues maintained by the HCA. Most preferably, the assigned completion queue is mapped to the specific event queue together with at least one other of the multiplicity of the completion queues.

There is additionally provided, in accordance with a preferred embodiment of the present invention, a network interface adapter, including:

a network interface, adapted to transmit and receive communications over a network;

a host interface, adapted to be coupled to a host processor, so as to enable the host processor to communicate over the network via the network interface adapter; and

processing circuitry, adapted to write information relating to the communications to a location in a memory accessible to the host processor and responsive to having written the information, to place an event indication in an event queue accessible to the host processor, and further adapted to assert an interrupt of the host processor that is associated with the event queue, so as to cause the host processor to read the event indication and, responsive thereto, to process the information written to the location.

There is further provided, in accordance with a preferred embodiment of the present invention, a host channel adapter (HCA), including:

a network interface, adapted to transmit and receive data packets over a switch fabric;

a host interface, adapted to be coupled to a host processor, so as to enable the host processor to communicate over the fabric via the HCA; and

processing circuitry, adapted to write a completion queue element (CQE) to a completion queue accessible to the host processor and responsive to having written the CQE, to place an event indication in an event queue accessible to the host processor, and further adapted to assert an interrupt of the host processor that is associated with the event queue, causing the host processor to read the event indication and, responsive thereto, to process the CQE.

In a preferred embodiment, the host interface is configured to couple the processing circuitry to the host processor via a parallel bus, and the processing circuitry is adapted to assert the interrupt by sending an interrupt message over the bus. Additionally or alternatively, the host processor has one or more interrupt pins, and the host interface includes one or more input/output pins, adapted to be coupled to the interrupt pins of the host processor so as to enable the processing circuitry to assert the interrupt therethrough.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a network communication system, in accordance with a preferred embodiment of the present invention;

FIG. 2 is a flow chart that schematically illustrates a method known in the art for interaction between a network interface adapter and a host processor;

FIG. 3 is a block diagram that schematically illustrates a hierarchy of queues and interrupts used by a network channel adapter, in accordance with a preferred embodiment of the present invention;

FIG. 4 is a state diagram that schematically illustrates states and transitions associated with event and interrupt handling, in accordance with a preferred embodiment of the present invention; and

FIG. 5 is a flow chart that schematically illustrates a method for interaction between a network interface adapter and a host processor, in accordance with a preferred embodiment of the present invention.

### DETAILED DESCRIPTION OF PREFERRED EMBODIMENTS

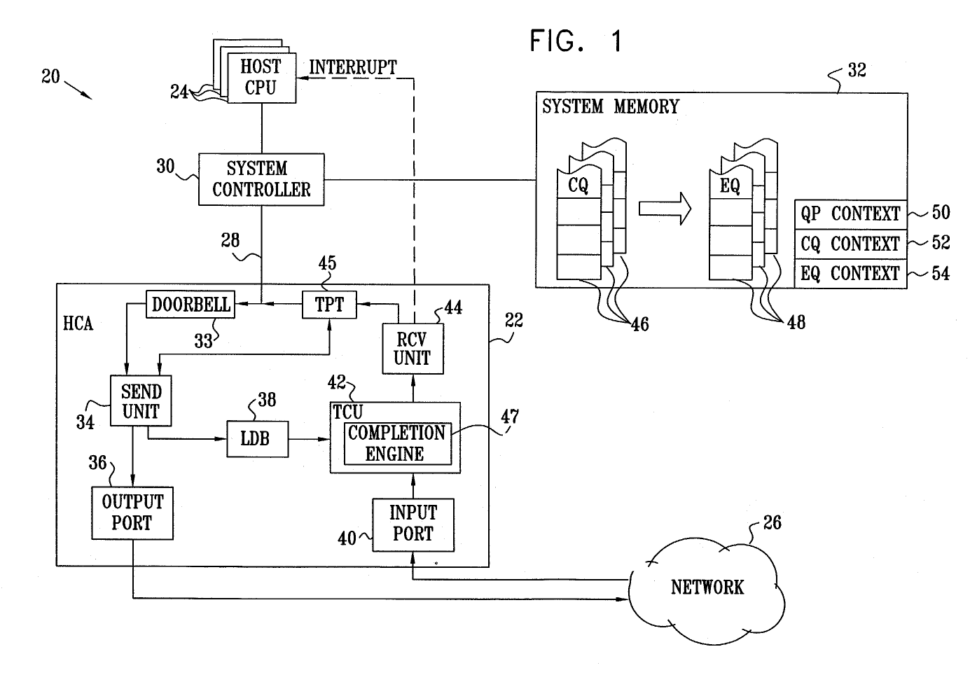

FIG. 1 is a block diagram that schematically illustrates an InfiniBand (IB) network communication system 20, in accordance with a preferred embodiment of the present invention. In system 20, a host channel adapter (HCA) 22 couples one or more host processors 24 to an IB network (or fabric) 26. Preferably, HCA 22 comprises a single-chip device, including one or more embedded microprocessors and memory on-board. Alternatively, multi-chip implementations may be used. Typically, each host 24 comprises an Intel Pentium™ processor or other general-purpose computing device with suitable software. Host 24 interacts with HCA 22 by opening and manipulating queue pairs (QPs), as provided by the above-mentioned IB specification. HCA 22 typically communicates via network 26 with other HCAs, as well as with target channel adapters (TCAs) connected to peripheral devices (not shown in the figures).

For the sake of simplicity, FIG. 1 shows only the details of system 20 and functional blocks of HCA 22 that are essential to an understanding of the present invention. Similarly, some of the interconnections between the blocks in HCA 22 are omitted from the figure. The blocks and links that must be added will be apparent to those skilled in the art. The various blocks that make up HCA 22 may be implemented either as hardware circuits or as software processes running on a programmable processor, or as a combination of hardware- and software-implemented elements. Preferably, all of the elements of the HCA are implemented in a single integrated circuit chip, but multi-chip implementations are also within the scope of the present invention.

Further details and other aspects of HCA 22 are described in a U.S. patent application entitled, “Network Interface Adapter with Shared Data Send Resources,” filed Dec. 4, 2001, which is assigned to the assignee of the present patent application, and whose disclosure is incorporated herein by reference.

Host 24 and HCA 22 are connected by a suitable system controller 30 to a system memory 32 via a bus 28, such as a Peripheral Component Interface (PCI) bus, as is known in the art. The HCA and memory typically occupy certain ranges of physical addresses in a defined address space on the bus. In order to send and receive messages over fabric 26, consumer processes on host 24 submit work requests to their assigned QPs by writing descriptors to memory 32. Each descriptor corresponds to a work queue element (WQE) to be executed by the HCA. After writing one or more descriptors to memory 32, the consumer process notifies HCA 22 that the descriptors are ready for execution by “ringing a doorbell” on the HCA, i.e., by writing to an assigned doorbell page 33 associated with the process, which is also used by the consumer process in interacting with completion and event reporting functions of the HCA, as described below.

When a consumer process rings its doorbell in doorbell page 33, a send unit 34 retrieves context information 50 regarding the QP from memory 32, and then reads and executes the descriptor. Access to memory 32 is controlled by a translation and protection table (TPT) 45, which thus serves as part of the interface between HCA 22 and the host system. Based on the descriptor and the context information, send unit 34 prepares and sends out one or more packets via an output port 36 to network 26. Upon sending the last packet in a given message, send unit 34 posts an entry in a local database (LDB) 38.

HCA 22 receives incoming packets from network 26 via an input port 40, which passes the packets to a transport control unit (TCU) 42. The TCU processes and verifies transport-layer information contained in the incoming packets. When an incoming packet contains data to be written to memory 32, TCU 42 passes the data that to a receive unit 44, which writes the data to memory 32 via TPT 45. An incoming request packet (such as a remote direct memory access—RDMA—read packet) may also request that HCA 22 return data from memory 32. In this case, TCU 42 passes a descriptor to send unit 34, which causes the send unit to read out the requested data and generate the appropriate response packet.

A completion engine 47 in TCU 42 also reads the entries from LDB 38 in order to create corresponding completion queue elements (CQEs), to be written to completion queues 46 in memory 32. (The completion engine is implemented for reasons of convenience as a part of the TCU, but functionally it is a distinct unit.) For unreliable services, the CQE can be written immediately, as soon as send unit 34 has generated the required packets. For reliable connections and reliable datagrams, however, completion engine 47 writes the CQE only after an acknowledgment or other response is received from the network. The completion queue 46 to which CQEs are to be written for a given work queue is typically indicated in QP context 50. (Context 50 for a given QP may also indicate that completion reporting is optional, in which case the descriptor for each message indicates whether or not a corresponding CQE is to be generated.) In preparing CQEs for each completion queue, TCU 42 uses completion queue (CQ) context information 52 stored in memory 32. Preferably, a portion of CQ context 52, as well as a portion of QP context 50, that is in active use by HCA 22 is stored temporarily in a cache memory on the HCA chip, as described in a U.S. patent application entitled “Queue Pair Context Cache,” filed Jan. 23, 2002, which is assigned to the assignee of the present patent application, and whose disclosure is incorporated herein by reference.

For each completion queue 46, CQ context 52 also indicates an event queue 48 to which the completion queue is mapped. Upon preparing a CQE, completion engine 47 checks CQ context 52 to determine the appropriate event queue for this completion queue and to ascertain that the event queue is enabled. If so, the completion engine prepares an event queue entry, which is written to the assigned event queue 48 by receive unit 44. To prepare the entry, the completion engine uses event queue (EQ) context information 54. When multiple interrupts are available (as in a multi-processor system), the EQ context preferably also indicates a mapping of this event queue to a designated interrupt of host processor 24. After writing the event queue entry to event queue 48, receive unit 44 asserts the designated interrupt to inform host 24 that there is an event waiting for service in the event queue. The interrupt may be asserted either by a direct connection of input/output (I/O) pins of HCA 22 to corresponding pins of host processor 24, or by sending an interrupt message over bus 28. EQ context 54 indicates the appropriate I/O pins or interrupt message for each event queue. Host 24 then services the event, as described in greater detail hereinbelow.

Although the operation of HCA 22 is described above with reference to completion events, it will be apparent to those skilled in the art that the same functional elements and methods may be used by the HCA to generate interrupts and report events of other types to host 24. Preferably, each type of event has its own event queue 48 and its own mapping to a host processor interrupt.

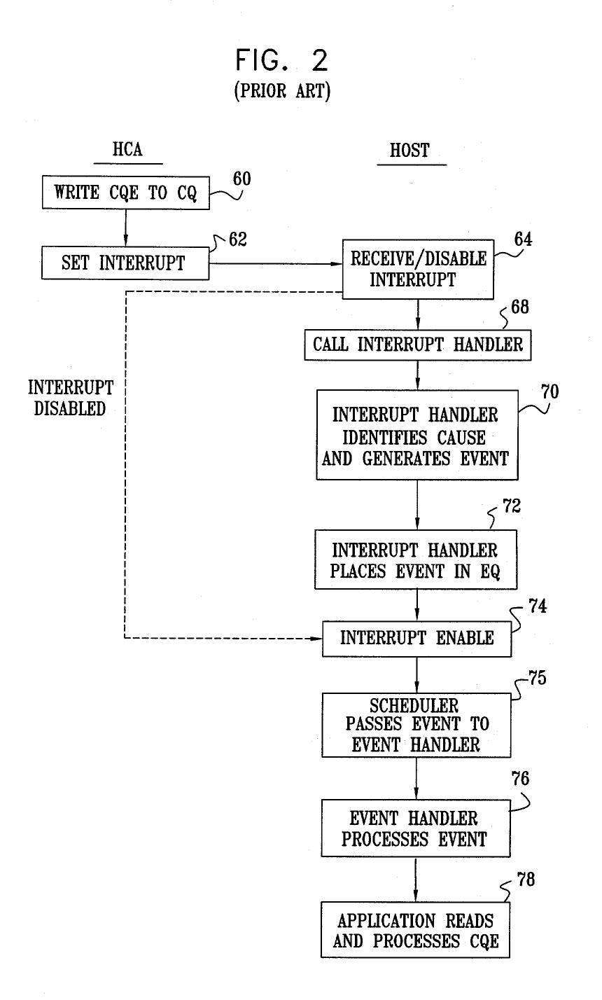

FIG. 2 is a flow chart that schematically illustrates processing of a CQE submitted by a HCA to a host in a system known in the art. The processing method shown in FIG. 2 is described here in order to clarify the distinction of the present invention over the prior art. The method of FIG. 2 uses similar data structures to those used by system 20: completion queues, as mandated by the IB specification, and event queues, for handling interrupts. In systems known in the art, however, these event queues are created and maintained by the host operating system, while the HCA is responsible only for entering CQEs in the appropriate completion queues and generating an interrupt if requested. For example, the above-mentioned InfiniBand specification defines only a single-event-queue model, and assumes that any further de-multiplexing of events is done in software.

The method of FIG. 2 is invoked by the HCA when it writes a CQE to a completion queue, at a completion writing step GO. The HCA then sets an interrupt, at an interruption step 62, to notify the host processor that a new CQE is waiting to be read. Typically, a single interrupt is used by the HCA to notify the host processor of any completion queue activity, regardless of which completion queue has received the new entry. Upon receiving the interrupt, the host processor disables the interrupt, at a disablement step 64. While the interrupt is disabled, host 24 will not respond to interrupts asserted by either the HCA or any other device. The HCA is thus prevented from notifying the host processor that it has written another CQE to the memory.

The interrupt asserted by the HCA causes the host processor to call an interrupt handler routine provided by its operating system, at an interrupt handling step 68. The interrupt handler identifies the cause of the interrupt, and accordingly generates an event indication (also referred to simply as an event), at an event generation step 70. It then places the event in the appropriate one of the host event queues, at an event queuing step 72. In general, only a single event queue is provided for all interrupts generated by the HCA. Typically, the host processor receives many interrupts from different sources, indicating different types of events, and therefore must also maintain multiple event queues for these different event types.

At this point, it is possible for the host once again to enable the interrupt, at an interrupt enable step 74. Alternatively, in some systems, it may occur that the interrupt is enabled even later, only after the event has actually been scheduled for service. At the least, the interrupt has been disabled at least for as long as it has taken the system to call the interrupt handler, and for the interrupt handler to generate and enqueue the appropriate event.

A scheduler routine provided by the host operating system intermittently checks the events in the event queues. As each event reaches the head of its queue, the scheduler passes it to an event handler routine, also provided by the host operation system, at a scheduling step 75. The event handler reads the details of the event that it has received from the scheduler, at an event processing step 76. The event indicates that a new CQE is waiting in one of the completion queues for service by a consumer application process. The event handler reports the CQE to the application, which accordingly reads and processes the CQE, at a CQE reading step 78.

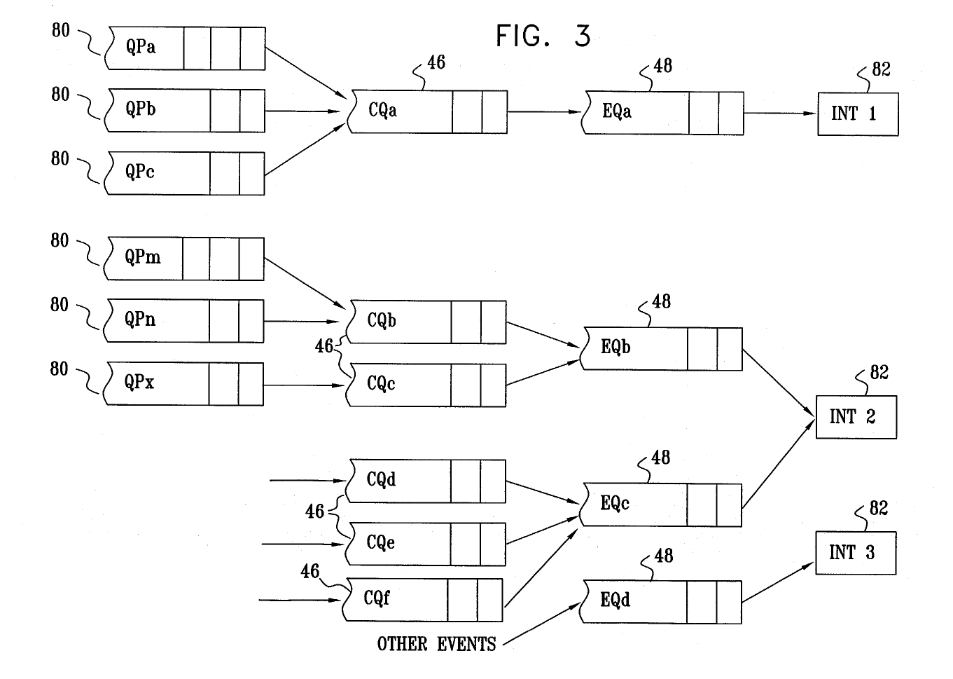

FIG. 3 is a block diagram that schematically shows a hierarchy of queues used by HCA 22, in order to provide enhanced event handling, in accordance with a preferred embodiment of the present invention. In contrast to the method described above with reference to FIG. 2, in which events are generated by host software, event queues 48 in system 20 are generated in hardware by the HCA. Furthermore, the HCA is capable of generating and maintaining multiple event queues, which are mapped to specific interrupts 82 provided by the host processor.

As described above, host 24 passes work requests to HCA 22 using multiple queue pairs 80. Typically, each of the queue pairs is mapped to one of completion queues 46, in either a one-to-one or many-to-one correspondence, as shown in FIG. 3. The mapping for each queue pair is indicated in QP context 50. Each completion queue 46 is preferably mapped to one of event queues 48, again using either one-to-one or many-to-one correspondence. The mapping is indicated by CQ context 52 for each of the completion queues. Preferably, each completion queue 46 is maintained in memory 32 as a virtually-contiguous circular buffer. Most preferably, each completion queue is mapped to two event queues 48: one for reporting completion events, and the other for reporting errors, such as completion queue overflow.

Event queues 48 may contain event entries of various different types generated by HCA 22. Each entry contains sufficient information so that event handler software can identify the source and type of the event. For completion events, the event entry in queue 48 preferably indicates the completion queue number (CQN) of completion queue 46 reporting the event. Other event types include, for example, page faults incurred by the HCA in accessing descriptors or data in memory 32; transport and link events on network 26; and errors either internal to HCA 22 or on bus 28. In addition, QP context 50 for a given work queue may be configured to enable generation of events directly upon completion of a descriptor on the work queue when an event flag in the descriptor is set. In this case, completion queues 46 are bypassed.

Preferably, as in the case of completion queues 46, each event queue 48 is maintained in memory 32 as a virtually-contiguous circular buffer, and is accessed by both HCA 22 and host 24 using EQ context 54. Each event queue entry preferably includes an “owner” field, indicating at any point whether the entry is controlled by hardware (i.e., HCA 22) or software (host 24). Initially, all the event queue entries in the event queue buffer are owned by hardware, until the HCA has written an entry to the queue. It then passes ownership of the entry to the software, so that the host software can read and process it. After consuming an entry, the host software sets its ownership back to hardware, and preferably continues in this manner until it reaches an entry that is owned by hardware, indicating that the valid entries in the queue have been exhausted.

EQ context 54 preferably also includes a “producer index,” indicating the next entry in the event queue to be written by the HCA, and a “consumer index,” indicating the next entry to be read by the host. The producer index is updated by the HCA as it writes entries to the event queue, while the consumer index is updated by the host software as it consumes the entries. The HCA writes the entries continually, and the host software likewise consumes them continually, until the consumer index catches up with the producer index. Before writing a new entry to the event queue, the HCA checks the values of the consumer and producer indices to make sure that the event queue is ready to accept the entry. This mechanism is useful in preventing race conditions that can lead to loss of events, as described in greater detail hereinbelow. Preferably, EQ context 54 also indicates another event queue to which the HCA can report errors in the event queue, such as buffer overflow.

Each event queue 48 is mapped to one of interrupts 82 of host 24. Preferably, when there are multiple interrupts available, as in a multi-processor system, there is a one-to-one mapping of the event queues to the interrupts. (Of course, if host 24 comprises only a single CPU with a single interrupt pin, all event queues are mapped to same interrupt.) Because the event queues are mapped in advance to the corresponding interrupts, when HCA 22 places an entry in an event queue and asserts the corresponding interrupt, the host event handler can read and process the event immediately, and there is no need to invoke the host interrupt handling and scheduling functions. Alternatively, as shown in FIG. 3, multiple event queues may be mapped to a single interrupt, in which case the host must demultiplex the entries but is still relieved of the burden of event generation.

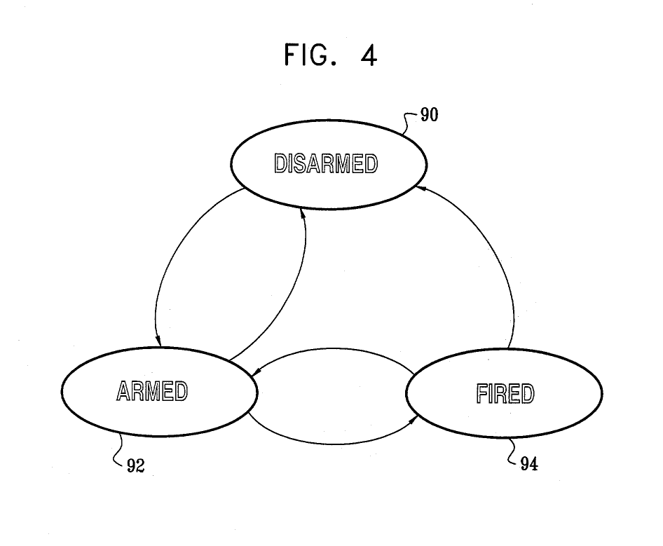

FIG. 4 is a state diagram that schematically illustrates interaction among completion queues 46, event queues 48 and interrupts 82 in the hierarchy of FIG. 3, in accordance with a preferred embodiment of the present invention. Initially, any given completion queue 46 is in a disarmed state 90, meaning that addition of CQEs to the completion queue will not cause HCA 22 to generate events. The completion queue transfers to an armed state 92 when a host process subscribes to the queue, i.e., when the host process asks to receive notification when completion information becomes available in this queue. The host process preferably submits its request for notification by writing an appropriate command to a designated field in its assigned doorbell page 33 of the HCA (FIG. 1).

While the completion queue is in armed state 92, existence of a CQE in the queue will cause the HCA to write an event entry to the appropriate event queue 48. If the completion queue is not empty when it enters armed state 92, the event will be written immediately. If the completion queue is empty at this point, the event will be generated as soon as a CQE is added to the completion queue. Upon generation of the event, the completion queue enters a fired state 94. In this state, additional CQEs may be added to the completion queue, but no more events are generated for this completion queue until the completion queue is explicitly re-armed by the host process.

Generation of interrupts 82 by event queues 48 is governed by a similar state transition relation. In this case, a given event queue will assert its corresponding interrupt only when the event queue is in armed state 92. After the interrupt has been asserted, and the event queue has entered fired state 94, the event queue will not reassert the interrupt until the host process has re-armed the event queue. At this point the interrupt is disabled, although the HCA may continue to write event entries to the event queue.

Before re-arming the event queue, the host software process preferably consumes all the outstanding entries in the event queue and updates the consumer index of the queue accordingly, until it reaches the producer index. (The software also changes the ownership of any consumed entries from “software” to “hardware.”) Preferably, the host process informs HCA 22 of the new consumer index by writing to a designated event queue field of its assigned doorbell page 33 (FIG. 1). The host process then re-subscribes to the event queue, so that the queue returns to armed state 92. At this point, HCA 22 can again assert the interrupt for this event queue to indicate to the host that a new event entry is ready to be processed.

The use of the state transitions shown in FIG. 4 prevents the HCA from adding new event entries prematurely, before the host process is ready to accept further events. When a given event queue is moved to armed state 92 by the host software, the HCA checks whether the consumer index for the given event queue is equal to the producer index before generating new event entries. If the consumer index for the queue is not equal to the producer index, the HCA generates the corresponding interrupt immediately. If the producer and consumer indices are equal, however, this means that no new events have been written since the last consumer index update. In this case, the HCA asserts the interrupt on the next event added to the event queue. As noted above, an event queue moves to “armed” state 92 when a host process subscribes to receive events on the queue. After receiving an interrupt, to the host process should consume all entries in the event queue, update the consumer index, and then subscribe for further events (arm the queue). A new interrupt will be generated if the queue is armed, and the consumer index is not equal to the producer index. Thus, if the HCA adds more events to the queue after the host process has finished with event consumption, but prior to arming the event queue, the interrupt will be asserted immediately upon arming of the event queue. If no events are added in this period, the interrupt will be asserted upon the next event.

This period—between the moment the host process is done consuming events from the event queue, but before it re-arms the queue so that the next interrupt can be generated—is a tricky period in which races can occur if no special care taken. Otherwise, the HCA might add further entries to the event queue just after the host software has finished consuming the previous entries, but before it has re-subscribed to be notified of the next event. In this case, the software might never receive notification of the event generated by the HCA. By waiting for the host software to re-subscribe to the event, the HCA prevents the race condition that could otherwise arise. A similar mechanism is preferably used in arming completion queues 46 and controlling the generation of completion events in event queues 48.

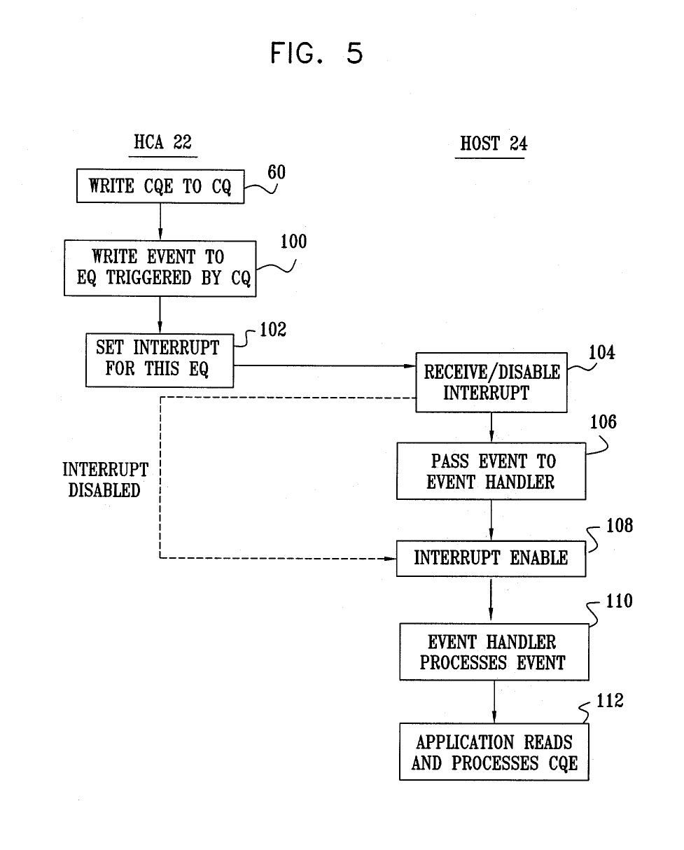

FIG. 5 is a flow chart that schematically illustrates a method for processing events in system 20, in accordance with a preferred embodiment of the present invention. This method takes advantage of the queue hierarchy shown in FIG. 3 and is based on the state transitions shown in FIG. 4. The method of FIG. 5 begins (like the prior art method shown in FIG. 2) when HCA 22 writes a CQE to one of completion queues 46 at step 60. When the completion queue is in armed state 92 (FIG. 4), the existence of the CQE causes HCA 22 to write an event entry to the event queue 48 to which this completion queue is mapped, at an event generation step 100. Then, similarly, assuming the event queue to be in the armed state, the HCA asserts the interrupt 82 that corresponds to this event queue, at an interrupt assertion step 102.

Host 24 receives the interrupt set by HCA 22, at an interrupt reception step 104, and disables the interrupt. As noted above, since the event entry is generated by HCA 22 instead of by host 24, there is no need for the host to call its interrupt handler (as at step 68 in FIG. 2). Instead, the event in queue 48 is passed directly to the host event handler, at an event receiving step 106. At this point, host 24 can re-enable the interrupt that was earlier disabled, at an interrupt enablement step 108. Upon comparison of FIGS. 2 and 5, it can be seen that the method of FIG. 5 should typically reduce substantially the length of time during which the interrupt must be disabled, relative to methods of interrupt handling known in the art.

The host event handler process the event entry that it has received, at an event processing step 110. As described above, the event entry identifies the type and originator of the event. In the case of completion events, the event entry indicates the completion queue 46 that caused the event to be generated. The event handler reports to the host application process to which this completion queue belongs that there is a CQE in the completion queue waiting to be read. The application then reads and processes the CQE in the usual manner, at CQE processing step 112.

Although preferred embodiments described herein relate mainly to reporting of completion information (in the form of CQEs) from HCA 22 to host 24, based on conventions associated with IB switch fabrics, the principles of the present invention may also be applied, mutatis mutandis, to other sorts of events, to different adapter/host interactions, and to other types of communication networks. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication between a network interface adapter and a host processor coupled thereto, the method comprising:
writing information using the network interface adapter to a location in a memory accessible to the host processor;
responsive to having written the information, placing an event indication, using the network interface adapter, in an event queue accessible to the host processor;
asserting an interrupt of the host processor that is associated with the event queue, so as to cause the host processor to read the event indication and, responsive thereto, to process the information written to the location.

2. A method according to claim 1, wherein writing the information comprises writing completion information regarding a work request submitted by the host processor to the network interface adapter.

3. A method according to claim 2, wherein writing the completion information comprises writing a completion queue element (CQE) to a completion queue.

4. A method according to claim 2, wherein writing the completion information comprises informing the host processor that the network interface adapter has performed at least one of sending an outgoing data packet and receiving an incoming data packet over a packet network responsive to the work request.

5. A method according to claim 1, wherein the information written to the location in the memory belongs to a given information category, and wherein placing the event indication comprises placing the event indication in a particular event queue that corresponds to the given information category, among a plurality of such event queues accessible to the host processor.

6. A method according to claim 5, wherein the given information category is one of a multiplicity of categories of the information written using the network interface adapter, and wherein each of the multiplicity of the categories is mapped to one of the plurality of the event queues, so that placing the event indication comprises placing the event indication in the particular event queue to which the given information category is mapped.

7. A method according to claim 5, wherein the interrupt is one of a multiplicity of such interrupts provided by the host processor, and wherein each of the plurality of the event queues is mapped to one of the multiplicity of the interrupts, so that asserting the interrupt comprises asserting the interrupt to which the particular event queue is mapped.

8. A method according to claim 7, wherein asserting the interrupt comprises mapping the particular event queue uniquely to a specific one of the interrupts, to which none of the other event queues are mapped, and asserting the specific one of the interrupts.

9. A method according to claim 8, wherein asserting the specific one of the interrupts comprises invoking an event handler of the host processor to process the event indication in response to the interrupt, substantially without invoking an interrupt handler of the host processor.

10. A method according to claim 1, and comprising writing context information with respect to the event queue to the memory using the host processor, and wherein placing the event indication in the event queue comprises reading the context information using the network interface adapter, and writing the event indication responsive to the context information.

11. A method for communication between a host channel adapter (HCA) and a host processor coupled thereto, the method comprising:
writing a completion queue element (CQE) using the HCA to a completion queue accessible to the host processor;
responsive to having written the CQE, placing an event indication, using the HCA, in an event queue accessible to the host processor;
asserting an interrupt of the host processor that is associated with the event queue, causing the host processor to read the event indication and, responsive thereto, to process the CQE.

12. A method according to claim 11, wherein writing the CQE comprises informing the host processor that the network interface adapter has executed a work queue element (WQE) responsive to a work request submitted by the host processor to the HCA.

13. A method according to claim 12, wherein informing the host processor comprises notifying an application process that submitted the work request that that the HCA has performed at least one of sending an outgoing data packet and receiving an incoming data packet over a switch fabric responsive to the work request.

14. A method according to claim 12, wherein the WQE belongs to a work queue assigned to the host processor, the work queue having a context indicating the completion queue to which the work queue is mapped, among a plurality of such completion queues maintained by the HCA, and wherein informing the host processor comprises writing the CQE to the completion queue that is indicated by the context of the work queue.

15. A method according to claim 11, wherein writing the CQE comprises writing the CQE to an assigned completion queue among a multiplicity of such completion queues maintained by the HCA, and wherein placing the event indication comprises writing the event indication to a specific event queue to which the assigned completion queue is mapped, among a plurality of such event queues maintained by the HCA.

16. A method according to claim 15, wherein the assigned completion queue is mapped to the specific event queue together with at least one other of the multiplicity of the completion queues.

17. A method according to claim 15, wherein asserting the interrupt comprises asserting a particular interrupt to which the specific event queue is mapped, among two or more such interrupts provided by the host processor.

18. A method according to claim 17, and comprising mapping the plurality of the event queues to respective interrupts provided by the host processor, such that the specific event queue alone is mapped to the particular interrupt.

19. A network interface adapter, comprising:
a network interface, adapted to transmit and receive communications over a network;
a host interface, adapted to be coupled to a host processor, so as to enable the host processor to communicate over the network via the network interface adapter; and
processing circuitry, adapted to write information relating to the communications to a location in a memory accessible to the host processor and responsive to having written the information, to place an event indication in an event queue accessible to the host processor, and further adapted to assert an interrupt of the host processor that is associated with the event queue, so as to cause the host processor to read the event indication and, responsive thereto, to process the information written to the location.

20. An adapter according to claim 19, wherein the information comprises completion information regarding a work request submitted by the host processor to the network interface adapter.

21. An adapter according to claim 20, wherein the completion information comprises a completion queue element (CQE), and wherein the location comprises a completion queue.

22. An adapter according to claim 20, wherein the completion information indicates that the network interface adapter has performed at least one of sending an outgoing data packet and receiving an incoming data packet over the network responsive to the work request.

23. An adapter according to claim 19, wherein the information written to the location in the memory belongs to a given information category, and wherein the processing circuitry is adapted to place the event indication in a particular event queue that corresponds to the given information category, among a plurality of such event queues accessible to the host processor.

24. An adapter according to claim 23, wherein the given information category is one of a multiplicity of categories of the information that the processing circuitry is adapted to write, and wherein each of the multiplicity of the categories is mapped to one of the plurality of the event queues, so that the processing circuitry places the event indication in the particular event queue to which the given information category is mapped.

25. An adapter according to claim 23, wherein the interrupt is one of a multiplicity of such interrupts provided by the host processor, and wherein each of the plurality of the event queues is mapped to one of the multiplicity of the interrupts, so that the processing circuitry asserts the interrupt to which the particular event queue is mapped.

26. An adapter according to claim 25, wherein the particular event queue is mapped uniquely to a specific one of the interrupts, to which none of the other event queues are mapped.

27. An adapter according to claim 26, wherein when the processing circuitry asserts the specific one of the interrupts, an event handler of the host processor is invoked to process the event indication in response to the interrupt, substantially without invoking an interrupt handler of the host processor.

28. An adapter according to claim 19, wherein the processing circuitry is adapted to read context information written to the memory by the host processor with regard to the event queue, and to write the event indication responsive to the context information.

29. A host channel adapter (HCA), comprising:
a network interface, adapted to transmit and receive data packets over a switch fabric;
a host interface, adapted to be coupled to a host processor, so as to enable the host processor to communicate over the fabric via the HCA; and
processing circuitry, adapted to write a completion queue element (CQE) to a completion queue accessible to the host processor and responsive to having written the CQE, to place an event indication in an event queue accessible to the host processor, and further adapted to assert an interrupt of the host processor that is associated with the event queue, causing the host processor to read the event indication and, responsive thereto, to process the CQE.

30. An adapter according to claim 29, wherein the processing circuitry is adapted to write the CQE so as to inform the host processor that the network interface adapter has executed a work queue element (WQE) responsive to a work request submitted by the host processor to the HCA.

31. An adapter according to claim 30, wherein the CQE is arranged to inform an application process that submitted the work request that that the HCA has performed at least one of sending an outgoing data packet and receiving an incoming data packet over the switch fabric responsive to the work request.

32. An adapter according to claim 30, wherein the WQE belongs to a work queue assigned to the host processor, the work queue having a context indicating the completion queue to which the work queue is mapped, among a plurality of such completion queues maintained by the processing circuitry, and wherein the processing circuitry is adapted to write the CQE to the completion queue that is indicated by the context of the work queue.

33. An adapter according to claim 29, wherein the processing circuitry is adapted to write the CQE to an assigned completion queue among a multiplicity of such completion queues that it maintains, and to write the event indication to a specific event queue to which the assigned completion queue is mapped, among a plurality of such event queues that it maintains.

34. An adapter according to claim 33, wherein the assigned completion queue is mapped to the specific event queue together with at least one other of the multiplicity of the completion queues.

35. An adapter according to claim 33, wherein the processing circuitry is adapted to assert a particular interrupt to which the specific event queue is mapped, among two or more such interrupts provided by the host processor.

36. An adapter according to claim 35, wherein the plurality of the event queues are mapped to respective interrupts provided by the host processor, such that the specific event queue alone is mapped to the particular interrupt.

37. An adapter according to claim 29, wherein the host interface is configured to couple the processing circuitry to the host processor via a parallel bus, and wherein the processing circuitry is adapted to assert the interrupt by sending an interrupt message over the bus.

38. An adapter according to claim 29, wherein the host processor has one or more interrupt pins, and wherein the host interface comprises one or more input/output pins, adapted to be coupled to the interrupt pins of the host processor so as to enable the processing circuitry to assert the interrupt therethrough.
